(19) United States
(12) Patent Application Publication
(10) Pub. No.: US 2007/0000947 A1
(43) Pub. Date: Jan. 4, 2007

(54) Apparatus and methods for dispensing fluidic or viscous materials

(76) Inventors: Russell H. Lewis, Rancho Santa Fe, CA (US); Mihai A. Solomon, San Diego, CA (US)

Correspondence Address: GAZDZINSKI & ASSOCIATES, Suite 375, 11440 West Bernardo Court, San Diego, CA, 92127, US

(21) Appl. No.: 11/173,868

(22) Filed: Jul. 1, 2005

(51) Int. Cl. B67D 5/60; B67D 5/52

(52) U.S. Cl. 222/132; 222/145.5; 222/145.6; 222/135

(57) ABSTRACT

Mixing and dispensing apparatus and methods for use with, e.g., a multi-component reactive material process is disclosed. In one embodiment, the apparatus comprises a series of positive displacement pumps adapted for stacked or “piggy-back” mating to a common motive source. At least one of the pumps is supplied by a sealed and collapsible reservoir bag and flexible tubing, thereby allowing removal (and optionally disposal) of one or more complete material pathways within the system. Such a configuration allows for, inter alia, rapid colorant changing with minimal material waste, obviates the use of hazardous solvents, and increases process efficiency and worker productivity. This arrangement also obviates complex metering apparatus common to prior art systems, thereby allowing it to be as small and power/cost efficient as possible.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

1. Field of the Invention

The present invention relates generally to the field of plural-component coating applications, and in one exemplary aspect to apparatus and methods for metering, mixing and delivering fluidic and/or viscous materials.

2. Description of Related Technology

A variety of different techniques for mixing and metering fluid and/or viscous components (such as reactive polymers used in applying coatings) are known in the prior art. For example, U.S. Pat. No. 2,847,196 to Franklin, et al., discloses one such arrangement generally representative of the prior art. This arrangement uses a complex arrangement comprising a plurality of static tanks, a mixing chamber, and a series of passageways for delivering the constituent materials to the mixing chamber. A solvent heater, tank and dispensing system are also provided for in order to purge the system after periods of non-use, etc.

U.S. Pat. No. 3,207,486 to Rosenthal discloses a mixing apparatus for mixing two or more reactive components. As with the invention of Franklin, et al. described above, the apparatus is complex, and includes many chambers and passageways that render it difficult to purge and clean after use or when switching constituent mixing components (e.g., changing colors).

U.S. Pat. No. 4,090,262 to Schneider, et al. issued on May 16, 1978 entitled “Mixing and proportioning apparatus for multi-component plastics materials” discloses a mixing and proportioning apparatus for multi-component plastics materials such as polyurethane comprises a number of tanks, a mixing chamber and a separate pipe connecting each tank to the mixing chamber. The tanks are provided with pressurizing means for causing the components to flow through the pipes and each pipe is provided with a metering mechanism to control the flow of the component through it. The metering mechanisms of the different pipes are all positively coupled to each other so that the rates of flow of the components through the pipes are all kept in constant proportions.

U.S. Pat. No. 4,126,399 to Schneider, et al. issued on Nov. 21, 1978 entitled “Method and apparatus for preparing multi-component plastic materials, particularly polyurethane, with solid material additives or at least one highly viscous component” discloses a method and apparatus for preparing multi-component plastic materials wherein at least one of the components is compounded with admixed solid materials or is highly viscous, the various components are continuously recycled and are metered separately by associated continuously operating feed pumps, and a mixing operation is effected in a mixing chamber served by a control piston. In the circuit for the compounded or viscous component a transmitter device is connected in a position downstream of the respective continuously operating feed pump and upstream of the associated mixing chamber inlet port. This transmitter device operates in a manner similar to a piston pump and increases the delivery pressure of the compounded or viscous component upon discharge into the mixing chamber whereby the operation of the transmitter is operatively coupled to the operation of the control piston at the mixing chamber. The component circuit may furthermore include a filling pump and a check valve.

U.S. Pat. No. 4,154,368 to Gusmer, et al. issued on May 15, 1979 entitled “Feeder for apparatus for ejecting a mixture of a plurality of liquids, with heated hoses” discloses a feeder for apparatus for ejecting a mixture of liquids, e.g. urethane foam, comprises a pair of swash plate proportioning pumps one individual to each of the liquids, e.g. resin and isocyanate, each proportioning pump being fed by a gear pump from a supply of the respective liquid. Seepage along the drive shafts of the isocyanate pumps is continuously removed by bathing them in a recirculating stream of flushing agent. The swash plate and gear pumps and flushing agent pump are all driven by a single motor from a common chain drive. The liquids are heated during passage through separate hoses to a common dispensing head or gun, by immersed coil electric resistance heaters extending lengthwise freely within the hoses. A novel control system is provided for the hose heater circuit, the adequacy of the liquid supply and other operating conditions.

U.S. Pat. No. 4,767,025 to Gebauer, et al. issued on Aug. 30, 1988 entitled “Hand tool for mixing and dispensing two-component masses” discloses in a hand tool for the mixing and metered dispensing of a two-component mass, a container holding a solid component mass is mounted in a handgun-like shaped support member. A mixing chamber is aligned with and mounted on one end of the container for mixing the components of the mass. A motor in the support member drives a drive shaft extending axially through the container. A mixing worm is connected to the drive shaft and is located within the mixing chamber. A metering pump is located within the support member for delivering a liquid component of the mass from a tank. The metering pump is a hose pump powered by the drive shaft. A conveying helix is positioned on the drive shaft in the container. Accordingly, since the drive shaft powers the metering pump and the conveying helix, a fixed mixture ratio of the solid and liquid components is delivered into the mixing chamber independently of the quantity dispensed. The mixed components flow out of the mixing chamber through a dispensing nozzle.

U.S. Pat. No. 4,854,482 to Bergner issued on Aug. 8, 1989 entitled “Dispensing device for flowable masses” discloses a device for dispensing metered quantities of flowable multi-component masses includes a housing with separate chambers, each containing a flexible bag with one component of the multi-component mass. Material is pressed out of the bags by a liquid propellant supplied from a reservoir in the housing to the chambers by gear wheel pumps located in a conduit connecting the reservoir to the chambers. The pumps are connected to a common drive so that the mixture ratio of the components is exactly maintained for any desired amount to be dispensed.

U.S. Pat. No. 4,881,821 to Stutz issued on Nov. 21, 1989 entitled “Apparatus for mixing and dosing synthetic resin components and process for the operation of this apparatus” discloses an apparatus for mixing and dosing at least two synthetic resin components to produce a single product includes a mixing head wherein the components are mixed together to form the product which is subsequently discharged. The mixing head includes a casing with an end port. A rotor drive shaft has a drive end extending out of the end port. A hollow mixing chamber which receives the components has a connection port adapted for detachable connection with the end port. A first quick connecting-disconnecting coupler mounted partially at the casing and port and partially at the chamber connection port detachably connects the casing to and disconnects the casing from the chamber. A rotor mechanism includes a mixing rotor disposed in the chamber. A second quick connecting-disconnecting coupler is mounted partially on the drive end of the shaft and partially on the rotor detachably connecting the shaft to and disconnecting the shaft from the rotor. The chamber and the rotor are disconnectable from the casing and drive shaft and can be replaced by a cleaning mixing chamber and a clean mixing rotor.

U.S. Pat. No. 5,388,764 to Moses issued on Feb. 14, 1995 entitled “Spray gun with orifice union” discloses an apparatus for mixing and spraying a catalyst with a resin onto a surface. The apparatus is provided with a restricted orifice union on the resin line running into the manifold. The union traps large plugs of resin and prevents them from entering and clogging the manifold. The union is designed so that plugs of resin may be easily removed from the resin line with only a minimum of down time.

U.S. Pat. No. 5,405,083 to Moses issued on Apr. 11, 1995 entitled “Spray gun with disposable mixer” discloses an apparatus for mixing and spraying a catalyst with a resin onto a surface. The resin and catalyst are internally mixed within a disposable mixing tube. After the spraying is completed, the catalyzed resin is allowed to harden within the tube and the tube is thereafter disposed of. Because the catalyst and resin are not mixed within any reusable portions of the spraying apparatus, the need for rinsing with acetone or similar hazardous solvents is eliminated.

U.S. Pat. No. 5,810,254 to Kropfield issued on Sep. 22, 1998 entitled “Low pressure polyurethane spraying assembly” discloses a low pressure spraying assembly for mixing and initiating the reaction of a first liquid reactive polymeric material, such as an isocyanate terminated compound, with a second liquid reactive polymeric material, such as an hydroxyl terminated compound or polyol resin, to form a two part polymer, such as polyurethane, and spraying the polymer onto a surface. The spraying assembly includes a material circulating system and a spray gun assembly. The material circulating system comprises separate multiple diaphragm pumps, drive assemblies, flow meters and feedback controllers for each material. The spray gun assembly includes a manifold with a pair of fluid ports for receiving the first and second polymeric materials. A mixing device is mounted to the manifold for mixing the materials to form the two part polymer. A spray tip with an air cap is mounted to the distal end of the mixing device for spraying the polymeric material. The air cap includes both a main outlet port for dispensing the polymer and atomizing outlet ports for atomizing the polymer. The spray gun assembly also includes an air purging operation for simultaneously removing any polymeric materials from the main outlet port and the atomizing outlet ports, thereby preventing any clogging of the atomizing outlet ports.

U.S. Pat. No. 6,062,492 to Tudor, et al. issued on May 16, 2000 entitled “Viscous material dispense system” discloses a viscous material dispense system including a dispense valve having an outlet, a mix tube secured at an upper end thereof to the outlet of the dispense valve, a mixer shroud positioned telescopically over the mix tube and including a conical lower end, and an air shroud fitted telescopically over the lower end of the mixer shroud and defining a conical surface positioned in confronting relation to the conical tip portion of the mixer shroud. The air shroud and the lower end of the mixer shroud coact to define a plurality of circumferentially spaced axially extending flutes extending downwardly between the outer surface of the mixer shroud and the inner surface of the air shroud and a plurality of circumferentially spaced radially extending flutes defined between the conical tip portion of the mixer shroud and the conical surface of the air shroud. Each radial flute communicates with a respective axial flute so that air enters proximate the upper end of the air shroud, moves downwardly between the air shroud and the mixer shroud as a series of axially spaced air streams, and thereafter moves radially inwardly between the lower end of the mixer shroud and the air shroud as a plurality of radially inwardly moving air streams which impinge upon a material bead exiting from the lower end of the mix tube to impart a swirling movement to the bead.

U.S. Pat. No. 6,131,823 to Langeman issued on Oct. 17, 2000 entitled “Low pressure dispensing gun” discloses a dispensing gun for atomizing a fluid under pressure with pressurized air includes a body having two fluid inlet structures and an air inlet structure defined in the body. An elongate barrel housing projects outwardly from the body. A longitudinal air passageway communicating with the air inlet structure and a longitudinal fluid passageway communicating with the fluid inlet structure are defined within the barrel housing. An atomizing structure for atomizing the fluid under pressure with the air under pressure is connected to the distal end of the barrel housing.

U.S. Pat. No. 6,250,567 to Lewis, et al. issued on Jun. 26, 2001 entitled “Apparatus and method for spraying single or multi-component material” discloses an apparatus and method for delivering single or multi-component material through a disposable delivery tube and atomizing the material into a spray pattern of substantially uniform dispersion. The apparatus includes a tubular manifold having an opening for receiving a disposable delivery tube with the exit end or nozzle of the delivery tube projecting out from the end of the manifold. A plurality of atomizer holes are formed in the end of the manifold surrounding the hole which receives the nozzle end of the delivery tube. A source of air under pressure is connected to direct air through the atomizer holes. An air cap is mounted to the manifold to direct air passing through the atomizer holes about the nozzle of the delivery tube to atomize the delivered material into a uniform spray pattern without the material coming into contact with either the manifold or the air cap.

U.S. Pat. No. 6,409,098 to Lewis, et al. issued on Jun. 25, 2002 entitled “Apparatus and method for spraying single or multi-component material” discloses an apparatus and method for delivering single or multi-component material through a disposable delivery tube and atomizing the material into a spray pattern of substantially uniform dispersion. The apparatus includes a tubular manifold having an opening for receiving a disposable delivery tube with the exit end or nozzle of the delivery tube projecting out from the end of the manifold. A plurality of atomizer holes are formed in the end of the manifold surrounding the hole which receives the nozzle end of the delivery tube. A source of air under pressure is connected to direct air through the atomizer holes. An air cap is mounted to the manifold to direct air passing through the atomizer holes about the nozzle of the delivery tube to atomize the delivered material into a uniform spray pattern without the material coming into contact with either the manifold or the air cap.

U.S. Pat. No. 6,601,733 to Schnacky, et al. issued on Aug. 5, 2003 entitled “Multi-component proportioning system and delivery system utilizing same” discloses a multi-component proportioning system for dispensing a multi-component coating composition is provided. The delivery system is intended for use in providing multi-component compositions to a multi-component dispenser. The system provides accurate mix ratios due to the consistent, reproducible displacement of components from the liquid pump assemblies used in the multi-component proportioning system regardless of viscosity. Such accuracy eliminates improper mixing of components that can lead to reworking and lost time, materials, and profits.

U.S. Pat. No. 6,601,782 to Sandholm, et al. issued on Aug. 5, 2003 entitled “Disposable spray nozzle assembly” discloses a disposable synthetic resin spray nozzle assembly for spraying reactive multi-component liquid mixtures includes a static mixer and an air or gas manifold. The static mixer has an elongated mixing tube containing a mixing element, and a liquid dispensing nozzle is formed at the downstream end of the mixing tube. A one-piece manifold has an inner wall which includes a mixer support section sealingly mounted around the static mixer, an air inlet section for receiving an air supply through a conduit, and an air dispensing section which, together with the outer wall of the liquid dispensing nozzle, forms an air dispensing nozzle. The reactive liquid mixture is atomized by air that supplied through the air dispensing nozzle.

U.S. Pat. No. 6,755,348 to Langeman issued Jun. 29, 2004 entitled “Third stream automotive color injection” discloses a method and system for dispensing a colored polymerizing composition. Two reactive components and one color component are pumped from respective containers at a metered volume. The color component, which is preferably a low-viscosity automotive paint is injected into either the first or second stream of reactive component at a point immediately prior to mixing all components in a dispensing device for dispensing the resulting colored fluid mixture onto a surface to be coated. The mixture may be dispensed by pouring or spraying onto the surface.

Despite the foregoing broad range of solutions to mixing and metering fluid/viscous components, all generally suffer from several salient deficiencies, including most notably: (i) the need for separate metering controls that are precisely adjusted in order to maintain the desired mixture ratio(s) of the constituents; (ii) use of mixing tanks, lines, etc., which must be thoroughly purged (usually at significant cost and expenditure of time and effort) before a different mixture (e.g., colors) can be used; purging of these prior art systems also requires use of solvents, which are costly, damaging to the environment if not disposed of properly, and potentially toxic to the operator(s) of the system; (iii) increased size and complexity (relatively speaking), thereby making them difficult to move and manage in confined spaces or situations where only one operator is present; and (iv) use of colorant reservoirs or “paint pots” that must be kept in a specific orientation (e.g., vent side up), and maintained vented to the atmosphere (the latter which causes some degree of unwanted curing or hardening of the material due to interaction with atmospheric gases and moisture). These prior art deficiencies are now discussed in greater detail.

Under existing prior art approaches, excessive waste and costly cleanup procedures characterize the main difficulties in combining and changing the colorant(s) used with reactive components. One such prior art method for mixing colorant into polyurethane comprises premixing a compatible colorant with a reactive base component at the storage tank level prior to passing the mixture through the delivery pumps and hoses towards the dispensing gun. The mixture of the base component (such as polyol) and colorant becomes unstable in a matter of 1 or 2 hours in the absence of continuous mixing and therefore it is necessary to mix the colorant prior to each application at approximately one minute per gallon in order to maintain a proper dispersion of the colorant in the mixture. During long periods of time without mixing, the colorant, which tends to be much heavier and more viscous than the polyol, tends to clog the passageways of the system, especially on the vacuum side of the system. In addition, it is often critical that a single batch be produced per job in order to ensure proper color matching. Because of this requirement there is often a significant waste that results via this “batch” method.

Also, changing colors is made difficult when using this method since there is a need to empty and clean the storage container and any exposed system passageways prior to each color change. Due to the nature of the colorants that are typically quite viscous (approx. 5000 cps or higher) this task is almost never accomplished thoroughly, creating a real challenge of matching both standard and custom colors since there is almost invariably contamination of the new color from one (or more) of the colors previously used within that system.

Other prior art methods do not “pre-mix” the colorant and polyol, but rather maintain the colorant in a “paint pot” or hopper. The process of filling colorant into a paint pot/hopper none-the-less creates significant cleaning difficulties, and requires an operator to perform numerous steps in order to prepare the system to apply a colored polyurethane coating. Typically, the process would require the operator to pour a colorant into the paint hopper, remove a locking pin and manually adjust a hand wheel or valve system. Further, for each change of color the operator would need to manually open and close appropriate valves (e.g., paint hopper valve, compressed air valve, and paint fluid line valve) in a multiplicity of different sequences based on whether the operator were either filling the paint hopper with color, taking air out of the system or preparing to inject the color stream into the reactive components.

Most significantly, each changeover requires the overall colorant injection system to be flushed and cleaned. Under prior art methods to clean and flush the colorant injection system (see, e.g., U.S. Pat. No. 2,847,196 to Franklin, et al. discussed previously herein), a solvent is used to remove any remnants of the previous colorant from the components of the injection system. This system remains largely inefficient because: (i) much of the colorant removed from the lines cannot be reclaimed, (ii) a significant quantity of solvent is needed to flush and clean the lines, such solvent presenting both a health hazard to the operator(s) and an environmental hazard, and (iii) trained operators are required, and must follow a specific procedure and sequence of steps in order to properly flush the system. In addition, any solvent residues that remain in the line(s) after flushing the system can subsequently result in uncontrolled reactions with the multi-component materials in a later application. These reactions could result in inconsistencies in the color of the colorant being applied, and/or negatively impact the reaction between the components during application (and even its physical properties after application and curing).

Also, because the colorant added to the reservoir and any reclaimed colorant after use would inherently be exposed to the atmosphere, the colorant may absorb unwanted humidity, and react with atmospheric gases (including hardening or “skinning over”), thereby potentially affecting the reaction between the other constituent components or the efficacy of the colorant itself.

As noted above, the metering of the colorant and reactive components under the prior art is also typically accomplished using multiple independent pumps, each having individual motors and controllers to properly combine the components in there required ratios (see, e.g., U.S. Pat. No. 6,755,348 to Langeman discussed previously herein). This added complexity is costly (requiring, e.g., multiple independent yet communicative controllers and circuitry), and generally provides for a system susceptible to both significant variations in metering (lack of precision) and failure. Such techniques also may require frequent adjustment due to changes in the density and/or temperature of the material(s) being metered, variations in atmospheric pressure, etc.

Based on the foregoing, what is needed are improved apparatus and methods that overcome the foregoing deficiencies of the prior art. Such improved apparatus and methods would ideally, inter alia, allow for rapid and easy change-over between different materials during operation, and obviate the need for use of costly, hazardous, and time-consuming purging techniques via solvents. Such apparatus and methods would also allow for precise metering of the various constituent components being mixed without the need for intricate mechanisms, electronic controllers, or frequent adjustments due to variations in material density/temperature, etc.

### SUMMARY OF THE INVENTION

The present invention satisfies the aforementioned needs by providing improved apparatus and methods for mixing, metering and dispensing fluids and/or viscous materials.

In a first aspect of the invention, a method of operating a material dispensing system is disclosed. In one embodiment, the method comprises: providing a plurality of substantially discrete material supply paths; operating said system with a first of said supply paths as part of said plurality; substituting said first supply path with a second path; and operating said system with said second supply path as part of said plurality.

In one variant, the system is adapted to dispense a mixture, and said act of providing comprises providing at least one pump, collapsible dispenser and tubing system as one of said material supply paths.

In a second aspect of the invention, a pump for use with a fluid or viscous material is disclosed. In one embodiment, the pump comprises: an outer casing, at least one input port and at least one output port; and a first shaft adapted for coupling to the shaft of an adjacent pump via a coupling mechanism; wherein said pump is adapted to be mated to said adjacent pump, and driven by a common motive force via said shaft of said adjacent pump. The first shaft is adapted for coupling to a second adjacent pump, said pump being substantially disposed between said first and second adjacent pumps such that the shaft of said pump is in communication with the shafts of each of said adjacent pumps.

In a third aspect of the invention, a multi-component material spray system adapted to spray a colored reactive component mixture is disclosed. In one embodiment, the system comprises: a dispensing apparatus with at least first, second and third input ports; a colorant-containing reservoir; at least three pumps commonly driven by a single motor, a first of said pumps being adapted to pump a first reactive component of said mixture, a second of said pumps being adapted to pump a second reactive component of said mixture, and a third of said pumps being adapted to pump colorant from said reservoir to said first port; wherein said dispensing apparatus, said reservoir and said third pump are physically coupled via at least one flexible tube.

In a fourth aspect of the invention, a system for mixing a plurality of component materials to form a mixture, and dispensing the mixture, is disclosed. In one embodiment, the system comprises: a plurality of pumps each adapted to pump one of said components, said pumps being driven by a common motive force; and a substantially sealed reservoir for at least one of said components, said reservoir and at least one of said pumps forming a removable pathway for said at least one component from said reservoir to a mixing and dispensing apparatus. The system advantageously requires no individual metering control for any of said pumps.

In a fifth aspect of the invention, a method for changing a material (e.g., colorant) used in a multi-component dispensing apparatus is disclosed. The method generally comprises changing out substantially entire the colorant pathway (including any pump(s)) thereby effectively obviating the use of any cleaning or purging solvents. In another variant, a peristaltic pump is used which obviates changing the relevant pump; rather, only the colorant reservoir and reservoir-to-dispenser (e.g., spray gun) line are changed.

In a sixth aspect of the invention, apparatus and methods allowing for changing of colorant with effectively no significant constituent material waste or use of solvent are disclosed.

In a seventh aspect of the invention, business methods allowing for reduced inventory and manufacturing burden relating to the aforementioned dispensing systems are disclosed.

### BRIEF DESCRIPTION OF THE DRAWINGS

The features, objectives, and advantages of the invention will become more apparent from the detailed description set forth below when taken in conjunction with the drawings, wherein:

FIG. 1 is a functional block diagram of a first exemplary embodiment of the mixing and dispensing system of the invention.

FIG. 1a is a front perspective view of the pump and motor assembly of the system of FIG. 1.

FIG. 1b is functional elevational view of one embodiment of the dispenser manifold used in the system of FIG. 1.

FIG. 1c is functional elevational view of an alternate embodiment of pump/motor assembly of the mixing and dispensing system, illustrating an alternate pump and motor configuration.

FIG. 1d is functional elevational view of another alternate embodiment of pump/motor assembly of the mixing and dispensing system, illustrating yet another alternate pump and motor configuration (two pumps only).

FIG. 1e is a perspective exploded view of one exemplary configuration of the dispenser element tip assembly of the system of FIG. 1.

FIG. 2 is a perspective view of one exemplary embodiment of the “piggyback” pump according to the invention.

FIG. 3 is a logical flow diagram illustrating one embodiment of the method of changing materials during operation using the system of FIG. 1.

FIG. 3a is a logical flow diagram illustrating another embodiment of the method of changing materials during operation, based on use of a peristaltic pump.

### DETAILED DESCRIPTION OF THE INVENTION

Reference is now made to the drawings wherein like numerals refer to like parts throughout.

As used herein, the term “pump” refers to any motive source capable of physically moving a material such as, without limitation, a fluid or viscous material.

As used herein, the term “positive displacement pump” refers to a type of pump which, for example, forces a material (e.g., fluid) from one chamber to another by reducing the volume of a first chamber while simultaneously increasing the volume of a second. These types of pumps produce constant measured flow of fluid over a wide range of pressures at either the input port or output port. Examples of positive displacement pumps include, but are not limited to, progressive cavity (e.g., screw), gear, lobe, piston, or peristaltic pumps.

As used herein, the term “reactive mixture” refers to any multi-component reactive mixture where each individual component, when mixed, result in a chemical reaction whereby the substantially liquid individual components harden into a substantially solid state after a relatively brief period of time. Examples of reactive components used to form a mixture include, without limitation, isocyanate and polyol, which when combined form a mixture that reacts into a substantially solid polyurethane coating.

As used herein, the term “dispensing” refers to any sort of release or provision of one or more materials to a desired location. Dispensing may comprise, without limitation and for example only, spraying (atomized or airless), pouring, and spattering-coating.

Overview

In one salient aspect of the present invention, an improved mixing and dispensing apparatus is disclosed for use in, inter alia, plural-component coating applications. The present invention seeks to overcome the limitations and deficiencies of the prior art, particularly those relating to the process of changing the color and/or type of materials dispensed during operation, and the metering of the colorant and reactive components of the system.

As discussed in greater detail subsequently herein, these deficiencies are overcome by providing a system for mixing the various components that is highly modular and simplified. For example, in one exemplary configuration, a stream of colorant material is mixed with first and/or second reactive material streams in such a way that the colorant container and flow path are hermetically sealed and separated from those of the other constituent materials until the mixing point of the system, thereby (i) avoiding any significant portion of the system from being contaminated with a particular colorant; and (ii) preventing the colorant stream from exposure to the atmosphere and thus unwanted atmospheric moisture, at all times. The system uses a set of matched pumps that are driven by a common motive source, yet separate and removable from one another. A sealed collapsible colorant pouch or reservoir is also used, as is polymer (e.g., “Tygon” or the like) tubing from the reservoir to the colorant pump. Because each color/component has its own reservoir, lines and pump dedicated exclusively for its application, entire flow paths of the system can be rapidly changed out during operation. Through use of sealing, the unused colorant in the lines, pump and reservoir may be set off to the side, ready for use once that color was again needed, without any significant degradation or hardening of the colorant.

This approach significantly reduces both the amount of wasted colorant, as well as completely obviating the solvents needed during the color change process of prior art systems. It also greatly speeds the colorant changeover process, allowing for dispensing of the desired (new) color literally only moments after dispensing a different color/material mixture with the same apparatus.

System

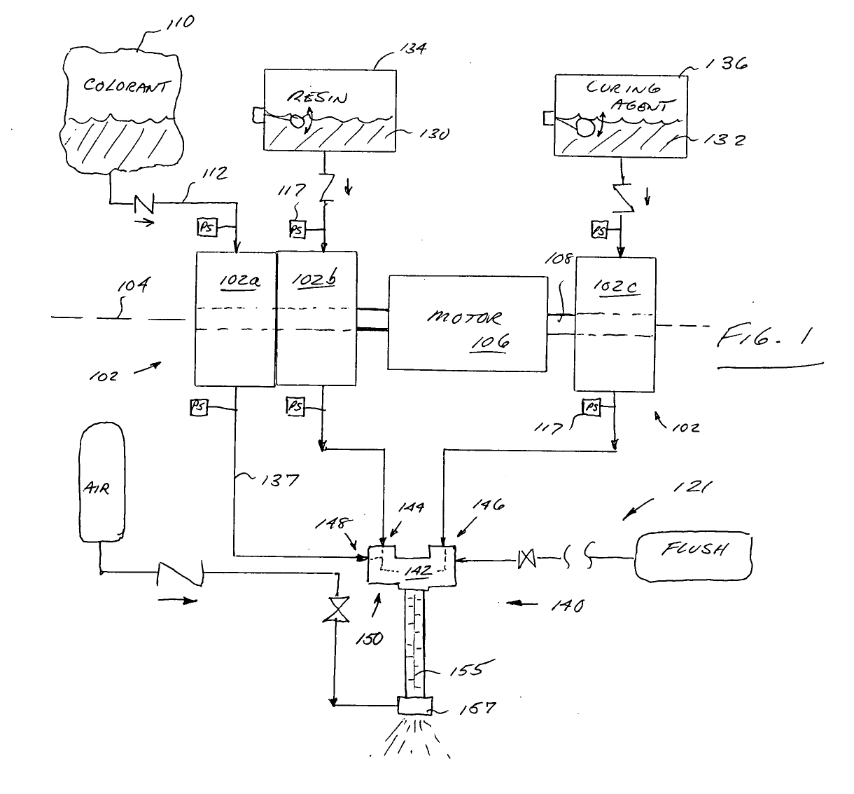

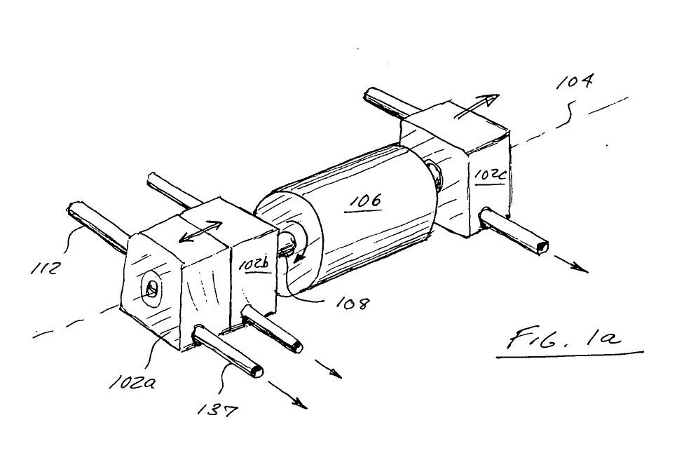

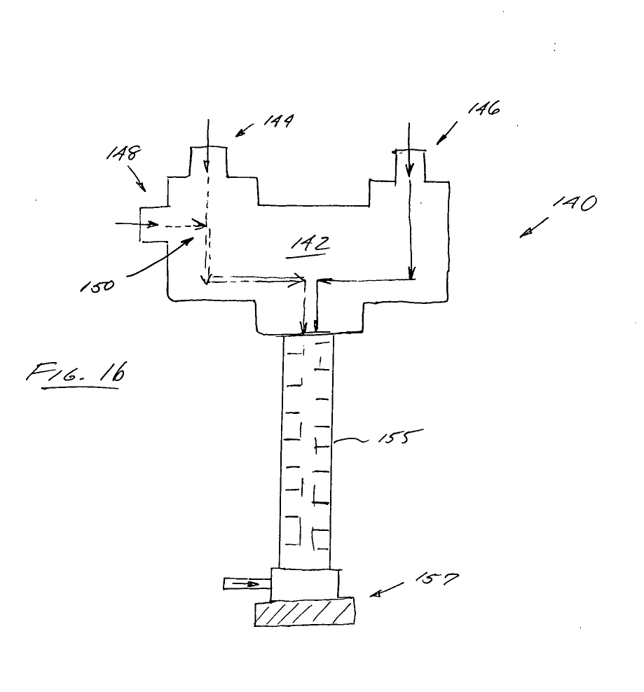

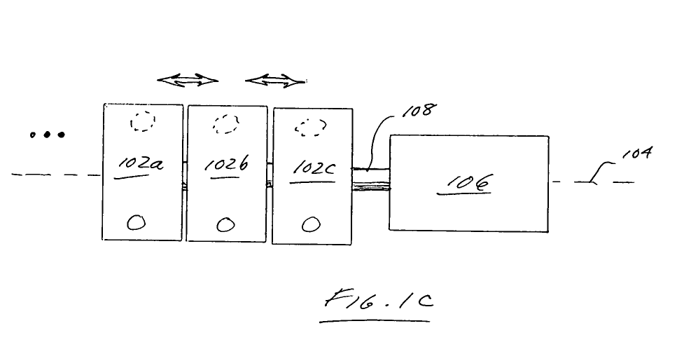

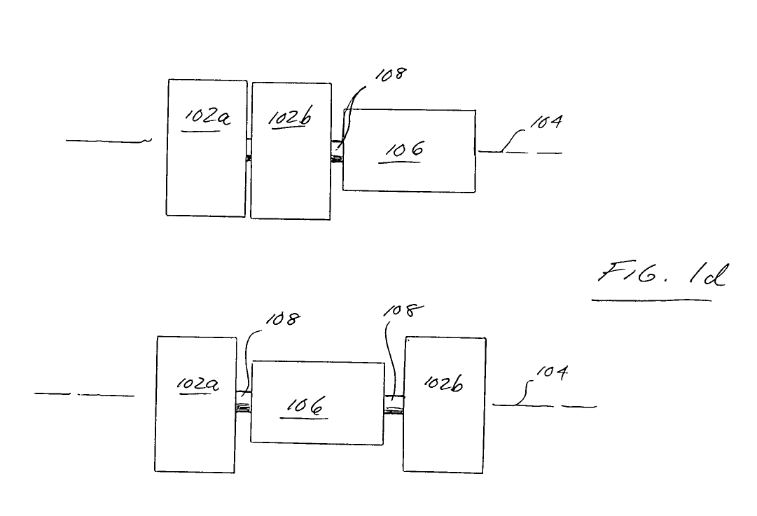

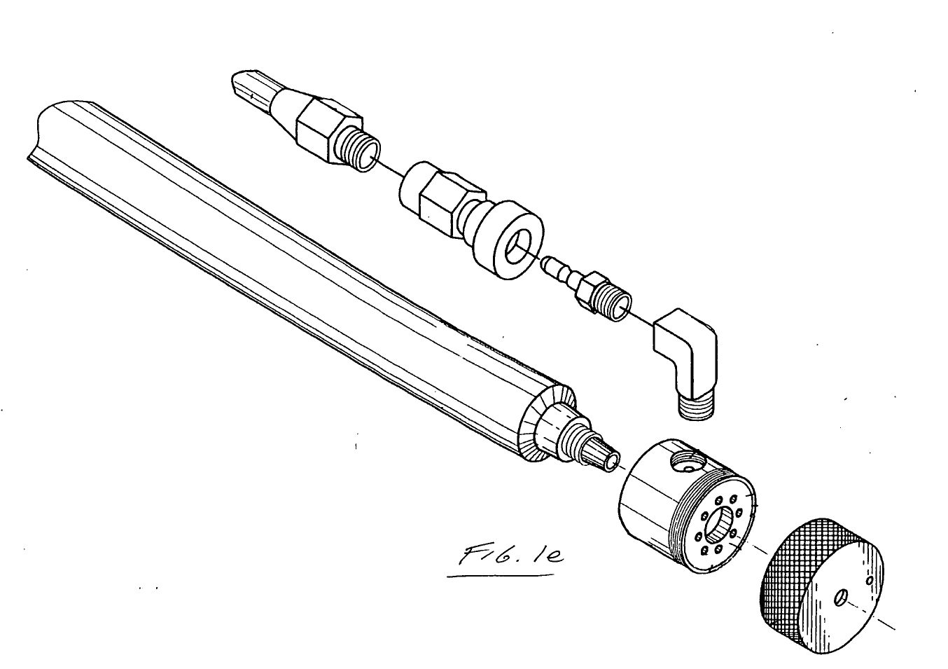

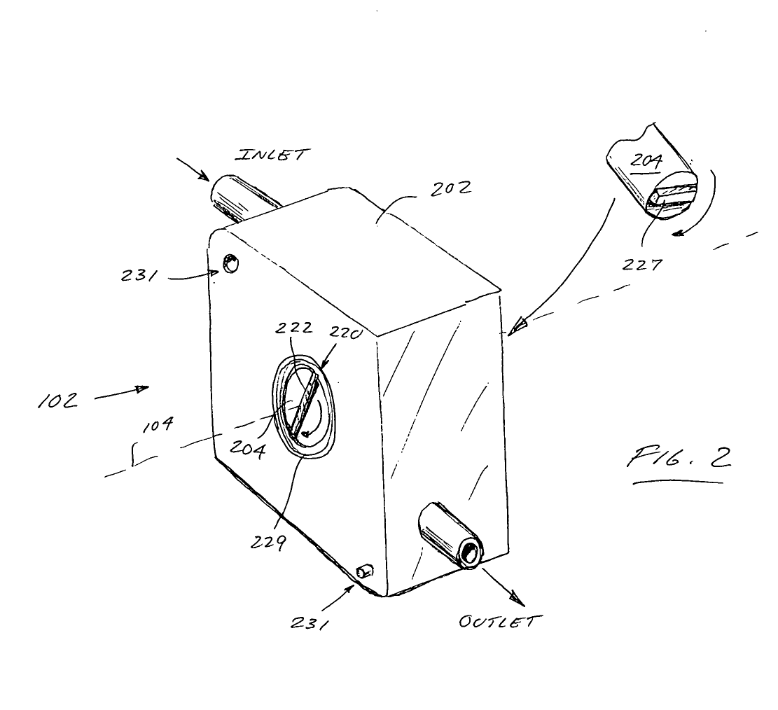

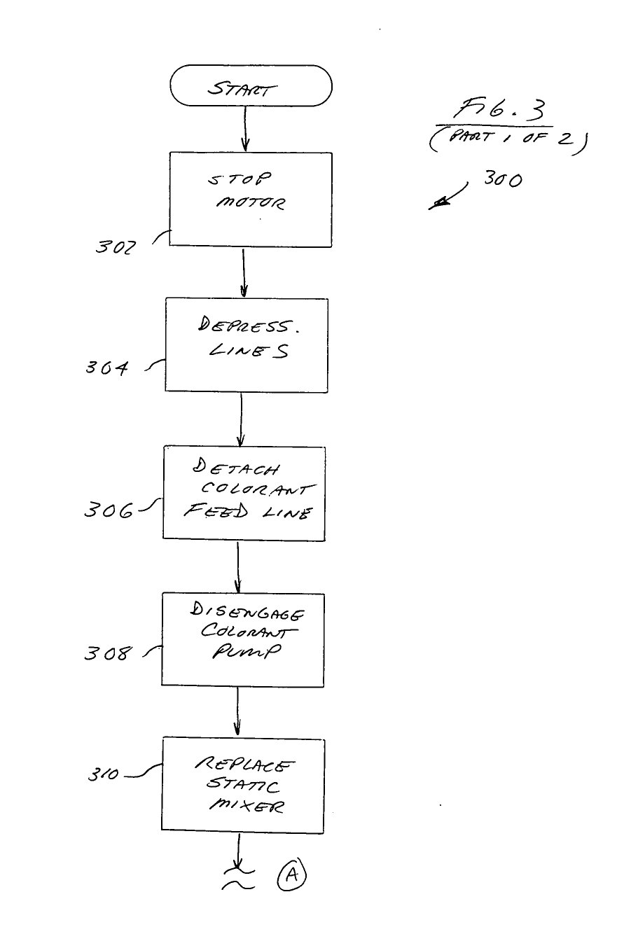

Referring now to FIGS. 1 and 1a, a first embodiment of the system for mixing and dispensing materials according to the present invention is described in detail. As shown in FIG. 1, the system 100 comprises a plurality (here, three) of pumps 102a, 102b, 102c arranged in substantially co-linear orientation along an axis 104. A motor 106 is also disposed proximate to the pumps 102, such that its drive shaft is substantially co-linear (or at least substantially parallel) with the axis 104. It will be appreciated, however, that flexible couplings or other similar arrangements may be used consistent with the invention, thereby allowing some misalignment between the axis 104 and the motor drive shaft. Furthermore, the drive shaft 108 coupled to the pumps 102 need not necessarily be the central shaft (e.g., rotor) of the motor 106, but rather may be the shaft of a mechanical gearing or out-drive arrangement of the type well known in the mechanical arts. The illustrated co-linear arrangement between the pump axes and the motor rotor axis, however, optimizes simplicity and reliability, as well as ease of pump swapping, as described in greater detail below.

Also shown in the embodiment of FIG. 1 is the colorant dispenser element 110, which is coupled to the colorant pump 102a via a Tygon or similar flexible tube 112. This dispenser 110 comprises in this embodiment a sealed plastic (e.g., polyethylene) collapsible bag containing the desired colorant(s). Advantageously, this sealed collapsible bag provides many distinct benefits, including inter alia (i) substantial insensitivity to the attitude of the bag relative to the pump 102a (i.e., the bag can be placed on its side, hanging from a support, and literally in any attitude relative to the local gravitational field without losing pump head or spilling the contents of the bag 110); (ii) sealing of the bag against atmosphere, thereby preventing exposure to humidity, air, contaminants, etc.; (iii) disposability (i.e., the bag can be merely thrown away when no longer needed). The bag can also be periodically shaken or tipped without any adverse effects, such as to prevent any stratification of the colorant or other material inside.

In one exemplary embodiment, the plastic bag 110 contains a mechanism, such as a check valve, so that the colorant could only flow in one direction only. The valve may also contain a fastening means (e.g., valved quick disconnect, tapered frictional fitting or the like) so that the pump supply line 112 can be easily coupled to and uncoupled from the bag. Myriad different approaches to coupling the bag 110 and the tube 112 in a substantially leak-tight and air-tight fashion are known to those of ordinary skill, and accordingly not described herein. The plastic dispenser bag 110 may also come pre-equipped with a feed line tube 112 already attached to the sealed pouch. The proximal end of the tube 112 would be semi-permanently or permanently attached to the plastic bag 110; the distal end may contain a valve or other sealing means that allows the user to easily prepare and connect the distal end to the inlet of the colorant pump 102a.

While the collapsible bag 110 is discussed primarily in its application with colorants, it is also contemplated that the present concepts could be used with other liquids or materials, such as for example the resins/reactive components discussed previously herein.

It is further contemplated that in the event a solvent purge of the system or other such evolution was desired, the collapsible bag/piggyback pump approach previously described herein may be used for this purpose as well.

Advantages similar to those discussed above with respect to the bag 110 (i.e., disposability/low cost, flexibility, and sealing) are also afforded by the use of the polymer supply tubing 112, 137, and hence this tubing is not described in greater detail.

Supply of the other mixture components (e.g., resin, curing agent, etc.) 130, 132 is provided by any number of different means, such as float-controlled tanks 134, 136 in the illustrated system 100 of FIG. 1. The optional float control system provides an auto-shutoff feature for the motor 106 in instances where the tank(s) empty, thereby preventing cavitation of the pumps and resulting damage, overspeeding of the motor, improper mixing ratios, etc. This is particularly useful where the system 100 is used for extended periods, thereby requiring frequent refills of the tanks; the operator is freed from having to periodically monitor the tank level, and rather can merely rely on the system to shut itself off when one of the tanks hits a prescribed critical level. Such float-controlled operation can also optionally instigate a user visual, audible or tactile alarm, or send a signal to another device (such as via wired electrical interface, or a Bluetooth or IEEE-802.11 wireless transceiver) indicating that refilling is necessary. For example, such a signal may cause a larger reservoir (located remote to the system 100) to pump more of the required material into the local tank 134, 136.

Similarly, any of the discharge or inlet of the pumps 102 can optionally be configured with an over- or under-pressure switch 1117, so as to shut the motor 106 off, instigate alarms, etc. when an undesired pressure condition occurs within the system. For example, if no recirculation path is provided within the system, the continued operation of the pumps 102 without dispensing any material may cause unwanted pressures to build up on the discharge side thereof (especially in the case where positive displacement pumps are used). The aforementioned pressure switch can therefore merely shut off the motor 106 until pressure drops below a preset control band, and/or a microswitch on the dispenser nozzle (discussed below) is actuated indicating that the discharge path is open.

Notwithstanding the foregoing, it is noted that the exemplary embodiment of the present invention does include such a recirculation path. In this embodiment, the recirculation path is put into service by manually connecting the hose ends at the gun 144, 146 to the material tanks for the isocyanate and resin. For the colorant, the recirculation consists of moving the colorant from one collapsible tank into another one by means of the colorant pump and hoses. Other recirculation configurations will also be recognized by those of ordinary skill given the present disclosure.

On the inlet side, the low pressure (or vacuum) switch can optionally be used to sense conditions where static head at the pump inlet(s) is insufficient to prevent cavitation or other unwanted artifacts of low inlet pressure from affecting the operation of the system 100. For example, if the colorant bag falls too far below the vertical height or level of the inlet of the colorant pump 102a, then the pump may not have sufficient draw to suck the colorant up the tubing 1112. It is also noted that as colorant is drawn out of the sealed colorant bag 110, a progressively larger vacuum/lower pressure (here, the term “vacuum” being used to refer to any pressure below prevailing atmospheric pressure) is created at the pump inlet. The physical force needed to deform the dispenser bag 110 is provided by the motive force of the pump 102a, and hence the static or other head produced at the pump inlet is necessarily reduced over that of pure ambient. When the colorant bag is completely sucked dry (and collapsed), an appreciable vacuum on the pump inlet may be created, thereby potentially damaging the pump 102a and motor 106 if not promptly addressed.

Similarly, under-pressure or vacuum switches can be used on the other component (resin, etc.) pumps 102b, 102c to preclude analogous conditions created by emptying of the tanks 134, 136.

Referring again to FIG. 1, the illustrated system 100 further comprises a dispensing element 140, here comprising a manifold 142 adapted to receive the three (3) components from respective ones of the pumps 102a, 102b, 102c. As shown in the detail of FIG. 1b, the manifold 142 receives the non-colorant components (e.g., resin, curing agent etc.) 130, 132 via separate inlets 144, 146 from tubing between the outlet of the respective pump and the manifold 142. The colorant inlet line 148 is mixed with one of the two components 130, 132 (here, the resin from pump 102b, although other approaches may be used) at a location 150 just before introduction of all three components (colorant, resin and clear) into the (static) mixing element 155, wherein the three components are mixed before dispensing. Since Tygon® or similar tubing 137 is used to provide the colorant discharged from the pump 102a to the manifold inlet 148, it is also easily disconnected (and disposed of if desired) when a color change is required. This manifold geometry is significant, in that it advantageously places the colorant in contact with only a very small portion of the manifold 142 before the mixing element 155 is reached. In the illustrated embodiment, a disposable mixing element 155 of the type well known in the art (such as, for example, that disclosed in U.S. Pat. No. 6,409,098 to Lewis, et al, incorporated herein by reference in its entirety) is used, thereby further eliminating portions of the colorant flow path (whether before, during or after mixing) that cannot be swapped out or replaced during a color/material change.

Hence, in the exemplary case where the user wishes to swap from color A to color B, he/she merely turns off the motor 106, disconnects the colorant pump 102a from the system 100 (including leaving the dispenser 110 and inlet/outlet tubing 112, 137 still attached to the pump 102a), and disconnects the distal end of the pump outlet tubing 137 from the manifold 142. The disposable static mixer 115 is removed and replaced with a clean one, and the new colorant assembly (i.e., pump 102a, dispenser 110, tubing 112, 137) fitted in place of the old as a unit. The distal end of the outlet tubing 137 is then fitted back onto the manifold 142, and the motor 106 turned on so that spraying of the new color (mixture) can commence. Since only a minute portion of the manifold (i.e., that between the colorant tube inlet 148 and the static mixer inlet) is still contaminated with the old colorant, only a very brief purge is required, and no solvents need be used. Tests by the assignee hereof of one commercial embodiment of the system 100 indicate that a complete color cross-over (i.e., from 100% coloration of the mixture by one color to 100% coloration by the second color) occurs within only a few seconds of discharge, contrasted with the use of solvents, and many minutes of spraying (and wasted materials) under the prior art approach.

Eliminating or reducing the use of solvent has benefits in at least two aspects: (1) unwanted chemical reactions between the colorant and the solvent are eliminated; and (2) health and environmental hazards associated with the use and disposal of the solvent is at minimum significantly reduced. In addition, because the system as a whole is hermetically sealed and the colorant is not exposed to the atmosphere, the shelf life of the colorant is increased, thus minimizing waste of the colorant in between different applications requiring the same pigment of colorant.

The system 100 of FIG. 1 is also optionally fitted with a flushing arrangement 121 comprising a solvent reservoir, isolation valve, and lines to the dispenser element 140, which may be used for cleaning of the manifold 142. It is noted that this subsystem 121 is not required during colorant (or other material) change-over as previously described, in contrast to prior art systems that would require such flushing as part of a color/material change.

It will be appreciated that while the embodiment of FIG. 1b shows a non-disposable manifold assembly 142, the present invention may be practiced using a fully disposable system, including where the manifold itself is made disposable (such as being fashioned from a polymer such as Teflon® (TFE), Tefzel® (ETFE), Delrin®, or any number of lower-cost materials suitable for such purpose. This approach completely obviates any “transitional” colors or material compositions during the change-over between a first and second color/material.

Furthermore, in another embodiment of the invention, the pumps 102 (as well as the colorant dispenser 112 and the lines 112, 137) are made disposable, such that they can literally be thrown away after use with very little cost. As described below in greater detail, the form factor of the pumps 102 can be made quite small, and their construction is quite simplified, such that they can readily be made from polymeric or similar components as well.

It will also be recognized that the novel pump and motor arrangement of the present invention may be modified as desired while still achieving the desired aims of modularity, low cost and ease of operation. For example, while the system 100 of FIG. 1 shows an exemplary configuration of “colorant pump-pump-motor-pump” (viewing the diagram from left to right), the order of each of these components can be permuted as desired. For example, in one alternate embodiment (FIG. 1c), the motor 106 is disposed at one end of the assembly 160, and the output shaft 168 is used to drive the first pump 162a (which can be any of the three constituents), which in turn drives the second pump 162b, which in turn drives the third pump 162c.

In another variant (FIG. 1d), only two mixture components are used, and hence a “piggyback” approach can be used (similar to that of FIG. 1b, yet with only two pumps), or alternatively an “end-to-end” approach used (i.e., similar to that of FIG. 1, yet with only one pump on each output shaft end of the motor 106).

It will also be appreciated that the compact arrangement of the system 100 of FIG. 1, and the flexibility afforded by the use of a colorant dispenser 110 that can be variably positioned and which does not leak, greatly increases the mobility of the system 100 as a whole. Specifically, the pumps 102 are each very small in size, and “stack” in a spatially piggy-back fashion relative to the motor. The elimination of gearboxes and the like allows the motor 106 to be smaller in size and capacity than it would otherwise, and the elimination of separate metering apparatus and controllers further reduces size and power consumption. Hence, the system 100 is lighter, easier to move, easier to assemble/disassemble, and consumes less electrical power, than prior art systems.

In another variation of the present invention, multiple colorant piggy-back pumps 102 are utilized in tandem to dispense two or more colors. For example, a first piggy-back pump could contain a first color pigment, while another pump could contain a second pigment. This dispensing may be contemporaneous, such as where both pumps are dispensing colorant simultaneously to tandem ports 148 on the manifold 142, or selective. In the latter instance, for example, the user may configure the system 100 to include multiple colorant pumps (e.g., four or five), and only selectively allow for mixing of one or two desired colorants at the same time, such as via a stop-valve arrangement at the manifold 142 wherein all pumps are turned simultaneously, but only the selected ones are permitted to be injected into the mixing chamber. This process can be controlled manually (such as via switches or buttons on the dispensing gun or manifold 142), or in automated fashion such as where the user merely selects a “green” button wherein the stop valves for blue and yellow colorant are concurrently opened to permit mixing of these two colors along with the other constituent components of the mixture. Because of the ratio-metric pumping of the plurality of pigments into a common stream (discussed below), a control mechanism for colorant ratios other than 1:1 (or 1:1:1, etc.) is needed. This control mechanism may comprise a manual control, or via a predetermined metering block or the like within the manifold 142 (that is consistent with the aforesaid aims of only very short runs of colorant line within the manifold to permit very rapid change-over/purging).

It will be appreciated that the system 100 (including the dispenser element 140) may be operated in an air-drive or airless configuration. In the exemplary embodiment, dispenser element also comprises a pressurized air source 170 which is fed into the dispenser tip cap 157 as described in detail in the aforementioned incorporated U.S. Pat. No. 6,409,098, and shown in FIG. 1e. This approach ensures that there is no appreciable physical contact between the mixed material and the internal passageways of the dispenser assembly. Specifically, the disposable static mixer 155 and end cap 157 so that the distal end or tip of the disposable mixer tube 155 projects a predetermined distance from the end of the cap 157, the latter being peripheral to the former. A plurality of atomizer holes formed in the distal end of the cap in a substantially symmetrical manner dispense pressurized air or other motive gas at a high velocity, thereby acting as an eductor/atomizer for the colorant/resin/curing agent mixture combined within the static mixer tube 155. The cap 157 hence does not come into contact with any of the mixed material. If the sprayed material sets, the disposable static mixer tube can be discarded and a new one inserted for another spraying operation. Due to the elimination of the necessity to clean the spray nozzle after each material application, the need for cleaning solvents is further eliminated. This makes the subject atomizer spray apparatus, along with the other aspects of the present invention previously described, extremely “environmentally friendly”.

In the air-less embodiment, no air source is provided. Rather, the mixed material is forced out the tip of the static mixer tube 155 (or comparable structure) and poured or, expelled under pressure sufficient to “spray” the material in a desired pattern and density. The tip of the static mixer 155, for example, may be equipped with a diffuser (not shown) of the type well known in the art, whereby the velocity of the mixture molecules and the diffuser cooperate to deflect the trajectory of the molecules in various directions. Other approaches may be used with equal success, or the pressurized mixture stream may simply dispensed as a stream without further shaping.

Piggy-Back Pump

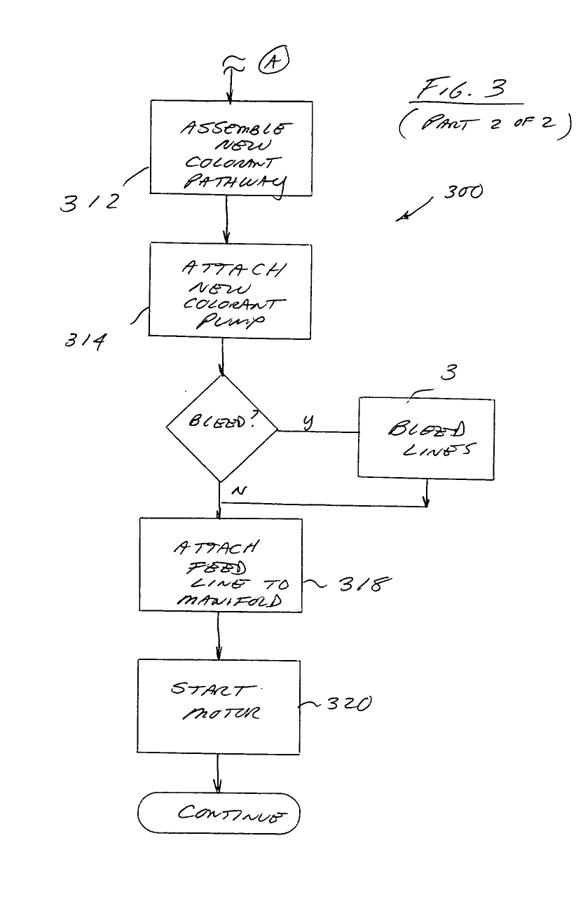

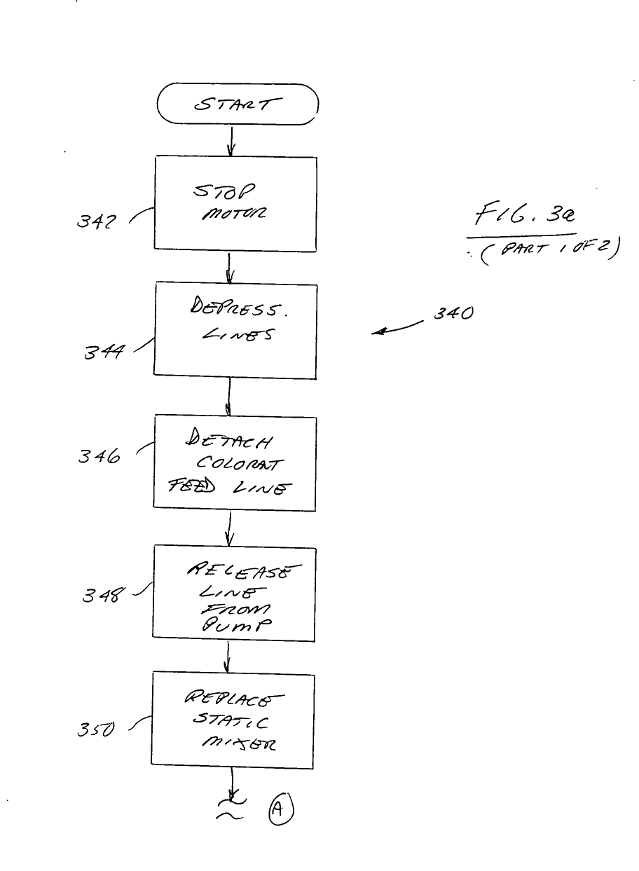

Referring now to FIG. 2, exemplary embodiments of the “piggy-back” pump 102 of the system 100 of FIG. 1 above are described. As shown in FIG. 2, the pump 102 comprises a rotary device having a housing or casing 202 and central keyed shaft 204, although other arrangements (such as a spline, set screws, pins, etc.) may be used in place of or in combination with keying. The keyed shaft 204 is intended to be coupled to another pump, or in the alternative to the motor 106, as previously described. Each pump 102 comprises male, female (or both) key elements 220 coupled to or formed in the drive shaft 204 for purposes of stacking or “piggy-backing” the pumps. These keyed elements 220 comprise a slot 222 and corresponding key 227 which are chosen to allow for positive and easy coupling, although other configurations (such as a cross, star, square, etc.) may be used with equal success. An alignment groove 229 is also optionally formed around the periphery of the shaft 204 in the housing 202 so as to cooperate with a corresponding ridge on the adjacent pump (not shown).

The pump internals (described below in detail) generally comprise a rotating positive displacement arrangement of the type well known in the mechanical arts), although this is not a requirement of the invention. Significantly, the use of a common motive source by each of the pumps 102a, 102b, 102c allows for a “ratio-metric” arrangement wherein each pump rotor rotates at precisely the same speed as the other pumps, and when coupled with their positive displacement output, provides very precise matching of the outputs of all three pumps.

It will be appreciated, however, that the use of a common motive source (e.g., motor 106) and common pump design renders the internal design of the pumps somewhat irrelevant so long as substantially identical devices are used for each pump. Specifically, the colorant(s) and reactive components 130, 132 are delivered to a mixing chamber within the manifold 142 in a precise ratio-metric volume by virtue of the equal characteristics and rpm (revolutions per minute) of each pump, and hence while positive displacement pumps offer the most precise control, other types of pumps (such as centrifugal) may conceivably be used for applications where their benefits (such as progressive flow rate as a function of backpressure) are desirable, assuming comparable backpressures on the discharges of all of the pumps. Discharge check valves and other such mechanisms may also be used to maintain such uniform conditions across all of the pump discharges (and suctions).

It will also be appreciated that while the use of a common motive force, common shaft and common positive-displacement pump design in the embodiment of FIG. 1 allows for the foregoing ratio-metric metering (thereby obviating separate metering devices or controllers), individual metering via e.g., throttle valves or the like may be optionally implemented consistent with the invention to provide very precise control of the flow from individual pumps 102. Furthermore, the pump capacities may be made heterogeneous (e.g., different output flow rates) where a mixing ration of other than 1:1:1 is desired. For example, if a ratio of 2:2:1 is desired, then two of the pumps 102 may be configured to have an output of twice that of the third pump.

The pumps are also optionally attached to one another via a quick-release mechanism 231 (e.g., frictional fasteners, latch-type clasps, rotate-to-lock/unlock mechanism, push-button ball/pin disconnects, Velcro® patches, etc.) such that one pump 102 can be swapped quickly for another pump without requiring tools. This mechanism 231 also optionally aligns the two adjacent pumps in the rotational plane so as to maintain them in proper orientation, although other means for accomplishing this goal may be used as well.

Another salient characteristic of the illustrated embodiment is that the pump 102 (and dispenser bag 110 and tubing 112, 137) are hermetically sealed so as to prevent air and moisture from reaching the colorant (or reactive components), thus preserving the properties of the colorant in the pump and surrounding feed lines for a specified storage life which greatly exceeds that of prior art “paint pot” or other approaches. This sealing is accomplished using any number of different techniques or design features, including the use of close tolerances between moving parts of the pump 102, use of gaskets/O-rings/sealers, etc. Furthermore, the somewhat viscous nature of the materials (e.g., colorant, resin, curing agent) being pumped acts as somewhat of a self-sealing agent, preventing the ingress/egress of any appreciable quantities of air/material, respectively.

In one exemplary variant of the pump(s) 102, a gear-type internal arrangement is used. This pump (not shown) generally comprises a casing, a pair of spur gears, an inlet port, an outlet port and a drive shaft to drive the spur gears. The casing is preferably made from a machined metal stock or alloy such as steel or aluminum, although other materials such as polymers or even ceramics may be used, as well as cast technology). The metal casing can be optionally coated with a finish suitably equipped to prevent against oxidation and the like, or an internal coating to facilitate reduced fluidic head loss and friction. This may be accomplished by a black oxide, fluorinated polymer or any other suitable alternative finish compatible with the base metal chosen. The base metal material chosen along with an optional finished surface are well understood in the arts, and hence no further description is required herein.

Alternatively the casing can be made from a polymer such as Nylon, TFE/ETFE, Ultem®, Delrin® or the like. Such alternative material can either be produced by traditional machining operations or by a molding process such as injection molding. Choosing between alternative base materials and construction methods will be based on a variety of variables such as volume, product shelf life, desired pump life, etc. and are well understood in the art and as such are not discussed further herein.

The spur gears of this exemplary embodiment can also be fashioned from a wide variety of materials. For example, C1018 steel is common, as are Stainless Steel, and Nylon (whether machined or molded). The material chosen should be optionally coated as to prevent against oxidation, wear, excessive friction and contamination of the colorant or reactive components. A suitable coating could be a fluorinated polymer such as Teflon® or chromium. Other alternatives and their tradeoffs are recognized by those of ordinary skill provided the present disclosure.

As previously described, the pump drive shaft 204 allows the pump to be multiply coupled to one another (and/or the motor) so that all the attached pumps are commonly driven. In another variant, gearing coupled to the drive shaft 204 (not shown) can be used to establish differential relative ratios between the pumps so that the colorant and reactive components are metered in their precise mixing ratios.

In a second exemplary embodiment, the pumps 102 comprise a progressive cavity (e.g., screw-type) positive displacement pump of the type well known in the arts. The overall design of the pump remains consistent with the principles set forth in the previous embodiment, except that the spur gears of the previous embodiment are replaced by a helical shaft such that when the shaft is rotated, fluid flow is induced.

In a third exemplary embodiment, the positive displacement pump comprises a peristaltic pump. A peristaltic pump is exemplified by its ability to induce fluid flow, particularly where those fluids have a special need to remain free from contaminants, or alternatively the fluid being passed is corrosive such that it is desirable to keep the fluid from coming into contact with any moving parts of the pump and corroding them. A peristaltic pump essentially comprises a casing, a flexible tube and a plurality of cams that slidably compresses the tube in a way that induces fluid flow. The flexible tube of this embodiment could be made of Tygon® or alternatively a blended PVC/polyurethane material as is common in peristaltic pump applications. An advantage of a peristaltic pump over other positive displacement pumps is that it is inherently hermetically sealed and naturally resists against contaminants and corrosion. In addition, any cleaning of internal moving components of the pump is not required. Depending on the fluid pressure that is required, the casing may optionally contain a lubricating fluid to prevent excessive wear as well as dissipate heat between the cams and the tubing.

The peristaltic pump approach also provides an inherent benefit from the standpoint that the fluid coupling between the colorant dispenser 110 (or tanks 134, 136) and the manifold 142 of the system of FIG. 1 can be continuous and unbroken; the pump(s) can be made to clamp over the existing Tygon or similar tubing 112, 137. Hence, with proper design, the piggyback pumps 102 need never be removed from one another or the motor 106; the operator simply releases the tubing from the pump, disconnects the distal end of the tubing from the manifold 142, and replaces the colorant dispenser 110 and tubing as a single unit. The new colorant tubing is then inserted into the appropriate pump 102a (unbroken), and its distal end connected to the manifold. The most obvious advantage of this approach (aside from improved sealing from having fewer tubing joints) is that fewer pumps are required. Specifically, a system 100 such as that of FIG. 1 required to dispense five (5) different colors would require five (5) separate colorant pumps. In contrast, the peristaltic embodiment described herein requires only one (1) colorant pump; only the tubing is changed for each color.

Method of Application

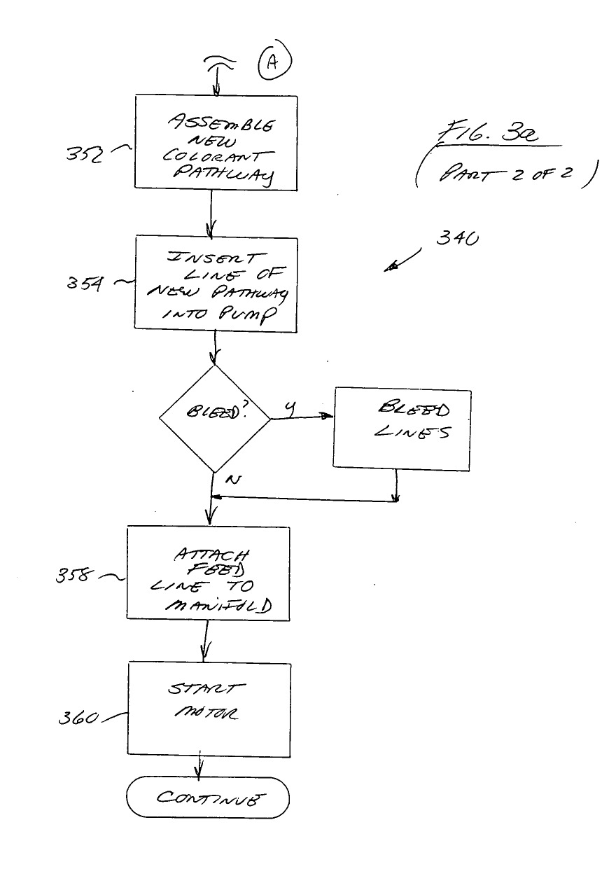

Referring now to FIG. 3, one exemplary embodiment of the method of operating the apparatus of the invention is disclosed. It will be appreciated that while the following method 300 is described in the context of a procedure for changing the colorant of a polyurethane coating, the method is more broadly applicable to changing any kind of material (e.g., from one resin type to another, etc.) as well as or instead of changing color. Hence, the method 300 is in no way restricted to colorants, and in fact no way restricted to polymer coatings.

For purposes of illustration, the method 300 of FIG. 3 assumes that the exemplary system 100 of FIG. 1 is operating and dispensing a first color (A). In the first step of the present method 300, the system motor 106 is stopped if running (step 302), and the spray dispenser 140 (and lines) depressurized such as by pulling the dispenser trigger (not shown) or otherwise relieving any pressure in the system 100 which may still exist (step 304). The colorant feed line 137 is next detached from the dispenser apparatus 140 (e.g., spray “gun”) per step 306. The detached line 137 may be plugged or capped to prevent leakage and ingestion of air into the line 137, or alternatively a stop-cock arrangement optionally present in the line 137 can be employed for such purpose or a valved quick disconnect system. Simply bending the flexible line 137 back on itself and taping it tightly in place also provides temporary sealing, however this approach is not optimal.

Next, the piggy back pump 102a used to induce fluid flow of the colorant to the spray gun 140 is disengaged from the common drive shaft of the piggy back pump/motor assembly (step 308). The entire colorant dispenser bag 110, pump feed line 112, piggy back pump 102a, and dispenser supply line 137 is set off to the side for use at a later time (or disposed of if made in a disposable configuration as previously described herein).

Per step 310, the (disposable) static mixer tube 155 is removed from the spray gun 140 and replaced with a new, unused static mixer tube. It will be appreciated that while use of a disposable static mixer 155 is highly desirable, the invention is in no way limited to such arrangements; a non-disposable device that can be cleaned, for example, may be used with success.

Per step 312, a new pigment colorant collapsible bag 110, pump feed line 112, pump 102a, and dispenser feed line 137 are assembled (if not already done so) for the new pigment colorant (B). This second piggy back pump 102a is then attached to the common drive shaft of the piggy back pump/motor apparatus in place of the pump just removed (step 314).

Next, per step 316, the feed line(s) 112, 137 are optionally bled to remove any air from the apparatus, and the distal end of the spray gun feed line 137 originating from the piggy back pump is attached to the spray gun 140 (step 318).

The motor 106 is then started (step 320), and the manifold 140 purged for a few seconds until all of the old colorant (A) is expelled, and the new colorant (B) emerges. As noted above, exemplary configurations of the invention built by the Assignee hereof indicate that this colorant purge process is highly efficient and takes but a few seconds of spray at normal flows and pressures.

It will be recognized that the aforementioned method 300 may be modified as necessary to accommodate any additional components or process steps (i.e., the addition of additional colorant piggyback pumps 102 and/or the replacement of a disposable pump, or different ordering of the pumps relative to the motor 106), and such modifications and alterations will be readily implemented by those of ordinary skill, given the present disclosure.

Referring now to FIG. 3a, another exemplary embodiment of the method of operating the apparatus of the invention is disclosed, adapted for use of a peristaltic pump. In the first step of the method 340, the system motor 106 is stopped if running (step 342), and the spray dispenser 110 (and lines) depressurized such as by pulling the dispenser trigger (not shown) or otherwise relieving any pressure in the system 100 which may still exist (step 344). The colorant feed line 137 is next detached from the dispenser apparatus 140 (e.g., spray “gun”) per step 346. The detached line 137 may be plugged, capped, shut-off, etc. as previously described to prevent leakage and ingestion of air into the line 137.

Next, the peristaltic pump 102a used to induce fluid flow of the colorant to the spray gun 140 is actuated to permit removal of the colorant feed line 137 (which in this case runs from the reservoir 110 to the manifold 142) per step 348. The entire colorant dispenser bag 110 and feed/supply line 137 is set off to the side for use at a later time (or disposed of if made in a disposable configuration as previously described herein).

Per step 350, the (disposable) static mixer tube 155 is removed from the spray gun 140 and replaced with a new, unused static mixer tube.

Per step 352, a new pigment colorant collapsible bag 110 and feed line 137 are assembled (if not already done so) for the new pigment colorant (B). This second piggy assembly is then inserted into the pumping mechanism of the peristaltic pump (step 354).

Next, per step 356, the feed line 137 is optionally bled to remove any air from the apparatus, and the distal end of the spray gun feed line 137 is attached to the spray gun 140 (step 358).

The motor 106 is then started (step 360), and the manifold 140 purged for a few seconds until all of the old colorant (A) is expelled, and the new colorant (B) emerges.

In addition to the application of colored polyurethane to surfaces such as truck beds and mine conveyor belts, it is appreciated that the present apparatus is applicable to the dispensing of numerous different kinds of materials. Materials that can be sprayed in accordance with the principles of the present invention (with proper adaptation of the equipment) include, without limitation, paints, glues or adhesives, stucco, mastics, sealants, foams, undercoating, and other types of coatings, as well as other types of polymer based formulations that contain more than one component.

Methods of Doing Business

As previously noted, the “piggy-back” pump arrangement and other aspects of the present invention provide a great flexibility; i.e., by providing a motor with dual-ended shaft keyed to receive a pump, and pumps which are agnostic as to disposition on the shaft (and relative to the other pumps), myriad different combinations and configurations can be assembled as desired by the user. This approach also advantageously relieves the business (e.g., manufacturing and inventory) facilities producing and stocking these devices from the burden or producing and stocking varying different components; rather, a “universal” motor and “universal” pumps can be provided to make literally any configuration desired by a customer. Furthermore, when one component breaks or requires change-out in the field, a specially configured replacement component is not required.

It is also noted that the use of substantially separate or discrete supply paths for, e.g., colorant, allows them to be swapped out between different systems. For example, if a first colorant pathway (e.g., dispenser 110, lines 112, 137 and pump 102a) is removed from one system, it can be readily installed on another similar system. Hence, in business settings where multiple systems 100 are in use, there is ready interchangeability of these colorant (or other material) pathways, thereby obviating having to purchase multiple such setups for each individual system.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A method of operating a material dispensing system, comprising:
providing a plurality of substantially discrete material supply paths;
operating said system with a first of said supply paths as part of said plurality;
substituting said first supply path with a second path; and
operating said system with said second supply path as part of said plurality.

2. The method of claim 1, wherein said material dispensing system is adapted to dispense a mixture, and said act of providing comprises providing at least one pump, collapsible dispenser and tubing system as one of said material supply paths.

3. The method of claim 1, wherein said act of providing comprises providing at least one pump, collapsible dispenser and tubing system carrying a first material as said first path, and said act of substituting comprises providing at least one pump, collapsible dispenser and tubing system carrying a second material as said second path, and replacing said first path with said second path.

4. The method of claim 1, wherein said act of providing comprises providing at least one pump, collapsible dispenser and tubing system that is substantially sealed from atmosphere and carries a first material, said substantially sealed path permitting said first path to be reused subsequent to its substitution.

5. A pump for use with a fluid or viscous material, comprising:
an outer casing, at least one input port and at least one output port; and
a first shaft adapted for coupling to the shaft of an adjacent pump via a coupling mechanism;
wherein said pump is adapted to be mated to said adjacent pump, and driven by a common motive force via said shaft of said adjacent pump.

6. The pump of claim 5, wherein said coupling mechanism comprises a keyed shaft.

7. The pump of claim 5, wherein said coupling mechanism comprises a splined shaft.

8. The pump of claim 5, wherein said pump comprises a positive displacement gear pump.

9. The pump of claim 5, wherein said pump comprises a peristaltic pump adapted to allow removal of a flexible line carrying said fluid or material.

10. The pump of claims 5, wherein said first shaft is adapted for coupling to a second adjacent pump, said pump being substantially disposed between said first and second adjacent pumps such that the shaft of said pump is in communication with the shafts of each of said adjacent pumps.

11. A multi-component material spray system adapted to spray a colored reactive component mixture, or a reactive filler component, comprising:
a dispensing apparatus with at least first, second and third input ports;
a colorant-containing reservoir;
at least three pumps commonly driven by a single motor, a first of said pumps being adapted to pump a first reactive component of said mixture, a second of said pumps being adapted to pump a second reactive component of said mixture, and a third of said pumps being adapted to pump colorant from said reservoir to said first port;
wherein said dispensing apparatus, said reservoir and said third pump are physically coupled via at least one flexible tube.

12. The system of claim 11, wherein said colorant-containing reservoir comprises a substantially sealed collapsible bag.

13. The system of claim 11, wherein said first and second components are disposed in substantially sealed collapsible bags.

14. The system of claim 11, wherein and said reservoir, said at least one flexible tube and at least one of said pumps are removable from said system as a unit.

15. The system of claim 14, wherein said pumps comprise positive displacement pumps.

16. The system of claim 11, wherein the relative positions of said pumps and said motor with respect to one another may comprise a plurality of distinct combinations.

17. The system of claim 11, wherein the rotors of said pumps and said motor are disposed along a common axis.

18. The system of claim 11, wherein said dispensing apparatus comprises a mixing chamber, and said apparatus is configured such that a distance from said first port to said mixing chamber is minimized.

19. The system of claim 18, wherein said mixing chamber is disposable, and said disposable chamber and minimized distance and cooperate to allow purging of said system of colorant without use of a solvent.

20. A system for mixing a plurality of component materials to form a mixture, and dispensing the mixture, comprising:
a plurality of pumps each adapted to pump one of said components, said pumps being driven by a common motive force; and
a substantially sealed reservoir for at least one of said components, said reservoir and at least one of said pumps forming a removable pathway for said at least one component from said reservoir to a mixing and dispensing apparatus.

21. The system of claim 20, wherein said system requires no individual metering control for any of said pumps.
